(19) United States
(12) Patent Application Publication
(10) Pub. No.: US 2026/0236626 A1
(43) Pub. Date: Aug. 13, 2026

(54) NODE BEARING VECTOR SYSTEM

(71) Applicant: Minseok Doo, Baltimore, MD (US)

(72) Inventor: Minseok Doo, Baltimore, MD (US)

(21) Appl. No.: 19/051,253

(22) Filed: Feb. 12, 2025

(51) Int. Cl. G06F 30/12; G06F 111/02

(52) U.S. Cl. CPC G06F 30/12; G06F 2111/02

(57) ABSTRACT

A system and method for 3D modeling using non-bearing vectors includes acquiring, for each node in a 3D dataset, a node vector in spherical coordinates; a vector depth for each node; a first set of bearing vectors at each depth; force components at each bearing vector; and a user-defined parameter for each pair of connected nodes; converting the node vector to cartesian coordinates; determining a second set of bearing vectors in cartesian coordinates; applying rotation matrices for each of the second set of bearing vectors; calculating force-influenced bearing vectors; aggregating cumulative bearing vectors for each line segment between each pair of connected nodes nodei and nodej; determining a final position for each line segment between each pair of connected nodes by adding the cumulative bearing vectors to the cartesian node vector; and constructing a Bezier curve between each pair of connected nodes.

### BACKGROUND

### Technical Field

The present invention relates, in general, to a 3D modeling method and system, and, more particularly, but without limitation, to a 3D modeling method and system employing node bearing vectors.

Polygon modeling is a widely utilized technique for representing 3D objects, serving a critical role in domains such as computer graphics, robotics, game development, and medicine. Subdivision surfaces are a fundamental method for enhancing the overall quality of polygon-based 3D models by subdividing the polygon mesh. Additionally, subdivision surfaces offer a promising complementary solution to NURBS.

For purposes of this disclosure, non-uniform rational basis spline (“NURBS”) is a mathematical model using basis splines (B-splines) that is commonly used in computer graphics for representing curves and surfaces. It offers great flexibility and precision for handling both analytic (defined by common mathematical formulae) and modeled shapes. It is a type of curve modeling, as opposed to polygonal modeling or digital sculpting. NURBS curves are commonly used in computer-aided design (CAD), manufacturing (CAM), and engineering (CAE). They are part of numerous industry-wide standards, such as IGES, STEP, ACIS, and PHIGS. Tools for creating and editing NURBS surfaces are found in various 3D graphics, rendering, and animation software packages.

However, rendering complex and smooth surfaces necessitates a large number of polygons, resulting in extensive polygonal datasets that may exceed the capacity of main memory and consequently degrade performance. To overcome the challenge of applying textures to polygonal models with minimal distortion, previous studies have explored the integration of polygon models with B-spline models.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records but otherwise reserves all copyright rights whatsoever.

### SUMMARY

In an aspect of the disclosure, a method for three-dimensional (3D) modeling is disclosed. The method includes acquiring, for each node in a 3D dataset, a node vector in spherical coordinates; a vector depth for each node; a first set of bearing vectors at each depth; force components at each bearing vector; and a user-defined parameter for each pair of connected nodes nodei and nodej; converting the node vector to cartesian coordinates to create a cartesian node vector; determining a second set of bearing vectors in cartesian coordinates; applying rotation matrices for each of the second set of bearing vectors; calculating force-influenced bearing vectors; aggregating cumulative bearing vectors for each line segment between each pair of connected nodes nodei and nodej; determining a final position for each line segment between each pair of connected nodes nodei and nodej by adding the cumulative bearing vectors to the cartesian node vector; and constructing a Bezier curve between each pair of connected nodes nodei and nodej.

In an aspect of the disclosure, a system for 3D modeling is disclosed. The system includes at least one memory configured to store computer executable instructions; and at least one processor configured to execute the computer executable instructions to: acquire, for each node in a 3D dataset, a node vector in spherical coordinates; a vector depth for each node; a first set of bearing vectors at each depth; force components at each bearing vector; and a user-defined parameter for each pair of connected nodes nodei and nodej; convert the node vector to cartesian coordinates to create a cartesian node vector; determine a second set of bearing vectors in cartesian coordinates; apply rotation matrices for each of the second set of bearing vectors; calculate force-influenced bearing vectors; aggregate cumulative bearing vectors for each line segment between each pair of connected nodes nodei and nodej; determine a final position for each line segment between each pair of connected nodes nodei and nodej by adding the cumulative bearing vectors to the cartesian node vector; and construct a Bezier curve between each pair of connected nodes nodei and nodej.

In an aspect of the disclosure, a non-transitory computer readable medium is disclosed. The computer program product includes computer executable instructions stored thereon, which when executed by one or more processors, cause the one or more processors for 3D modeling. The computer program product includes computer executable instructions to: acquire, for each node in a 3D dataset, a node vector in spherical coordinates; a vector depth for each node; a first set of bearing vectors at each depth; force components at each bearing vector; and a user-defined parameter for each pair of connected nodes nodei and nodej; convert the node vector to cartesian coordinates to create a cartesian node vector; determine a second set of bearing vectors in cartesian coordinates; apply rotation matrices for each of the second set of bearing vectors; calculate force-influenced bearing vectors; aggregate cumulative bearing vectors for each line segment between each pair of connected nodes nodei and nodej; determine a final position for each line segment between each pair of connected nodes nodei and nodej by adding the cumulative bearing vectors to the cartesian node vector; and construct a Bezier curve between each pair of connected nodes nodei and nodej.

The foregoing summary is illustrative only and is not intended to be in any way limiting. In addition to the illustrative aspects, aspects, and features described above, further aspects, aspects, and features will become apparent by reference to the drawings and the following detailed description

Other systems, methods, features, and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 a flowchart for acts taken in an exemplary method for 3D modeling, according to an aspect of the disclosure.

FIG. 2 shows components of one aspect of a computing environment for 3D modeling, according to an aspect of the disclosure.

FIG. 3 shows one aspect of a client computer for 3D modeling, according to an aspect of the disclosure.

FIG. 4 shows one aspect of a network computer that may at least partially implement one of the various aspects for 3D modeling, according to an aspect of the disclosure.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the following description, numerous specific details are set forth to clearly describe various specific aspects disclosed herein. One skilled in the art, however, will understand that the presently claimed invention may be practiced without all of the specific details discussed below. In other instances, well known features have not been described so as not to obscure the invention. As described herein, the term “pivotally connected” shall be used to describe a situation wherein two or more identified objects are joined together in a manner that allows one or both of the objects to pivot, and/or rotate about or in relation to the other object in either a horizontal or vertical manner. As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify aspects of the invention and that other alternative mechanical configurations are possible.

Traditionally, 3D modeling has relied on two primary methods:

Polygonal Modeling: This technique uses polygons (usually triangles or quadrilaterals) to represent 3D objects. Artists define vertices in 3D space and connect them to form the surfaces of objects. While polygonal modeling is versatile and widely supported by rendering hardware, achieving smooth surfaces requires a high density of polygons, which can lead to large file sizes and performance issues.

NURBS Modeling: NURBS uses mathematical representations to create smooth curves and surfaces. It allows for precise control over complex shapes with relatively fewer control points. NURBS is favored in industries that require high precision, such as automotive and aerospace design. However, NURBS models can be computationally intensive and may not integrate seamlessly with real-time rendering pipelines used in gaming and interactive applications.

Other traditional practices include:

Subdivision Surfaces: A method that refines polygonal meshes to create smoother surfaces by recursively subdividing polygons. While it produces smoother results, it also significantly increases the number of polygons, affecting performance.

Separate Toolsets and Workflows: Different modeling techniques often require separate software tools and workflows. Transitioning a model from one method to another can be cumbersome and may involve conversion processes that risk data integrity.

Limited Real-Time Interaction: High-detail models often cannot be manipulated in real-time due to hardware limitations, leading to slower design iterations and reduced productivity.

Some of the drawbacks and disadvantages of conventional 3D modeling may include:

High Memory Consumption: Rendering complex and smooth surfaces using polygonal modeling requires a large number of polygons. This leads to extensive datasets that can exceed the capacity of main memory, causing performance degradation and longer processing times.

Performance Issues: The computational load increases with the number of polygons, making real-time interaction and rendering challenging. High polygon counts can strain hardware resources, leading to slower frame rates and less responsive modeling environments.

Texture Mapping Difficulties: Applying textures to polygonal models without distortion is complex. Traditional methods struggle with minimizing texture distortion on complex surfaces, requiring additional techniques like UV unwrapping, which can be time-consuming and less efficient.

Separate Modeling Workflows: Polygonal modeling and NURBS are often used separately, each with distinct tools and workflows. This separation can cause inefficiencies, especially when converting models between formats, potentially leading to data loss or the need for re-topology.

Limited Flexibility: Traditional methods may not offer the flexibility needed to efficiently handle both simple and complex geometries within the same framework. Adjusting models often requires significant manual intervention.

Inefficient Use of Hardware Capabilities: Existing methods may not fully leverage modern GPU parallel processing capabilities, leading to suboptimal performance and longer rendering times.

Data Precision Issues: Converting between different coordinate systems (e.g., spherical to Cartesian) can introduce rounding errors due to floating-point precision limitations, resulting in data loss and reduced accuracy in the final models.

The following briefly describes the aspects of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

The present disclosure relates to a Node Bearing Vector (NBV) system and method, a novel 3D modeling method that combines polygonal modeling with NURBS using node vectors, bearing vectors, variable edge lengths, and vector depth. In an aspect of the disclosure, the disclosed NBV system and method provides a flexible, memory-efficient alternative to traditional polygon modeling while delivering quality comparable to NURBS. In an aspect, a polygon-editing tool is disclosed that may support real-time interaction with near-NURBS accuracy.

An aspect of the disclosure includes a ‘Normalized Fixed-Point’ 64-bit integer format to precisely represent numbers between −1 and 1, combining the speed of integer operations with floating-point-like accuracy and reducing rounding errors. Offering about 19 decimal digits of precision, this method is ideal for 3D graphics, scientific simulations, and financial calculations, though it may require adaptations for applications needing a broader range of values. Equation (1) below converts the normalized value xnorm into a 64-bit fixed-point integer within the range [0, 2⁶⁴−1].

$${x}_{fixed} = ( \frac{{x}_{norm} + 1}{2} ) \times ( {2}^{64} - 1 ) \qquad ( 1 )$$

First, xₙₒᵣₘ, which is in the range [−1, 1], is scaled to [0, 1] by adding 1 and dividing by 2. Then, it is multiplied by 2⁶⁴−1 to map it to the full range of a 64-bit unsigned integer. This transformation allows leveraging the speed of integer operations while maintaining high precision.

$${x}_{norm} = 2 \times \frac{{x}_{fixed}}{{2}^{64} - 1} - 1 \qquad ( 2 )$$

In an aspect, Equation (2) reverses the fixed-point conversion, restoring the normalized value xnorm from the 64-bit fixed-point integer xfixed. It first scales x_{fixed} back to the [0, 1] range by dividing by [0, 2⁶⁴−1]. Then, it adjusts the scale to [−1, 1] by multiplying by 2 and subtracting 1. This may allow accurate reconstruction of the original normalized value from its fixed-point representation.

In an aspect of the disclosure, the disclosure system and method may include node vectors, bearing vectors, and vector depth within a spherical coordinate system centered by an origin vector. The disclosed NBV system processes object files containing Node vectors and Bearing vectors, rendering surfaces through connected Line Segments to create flexible and efficient 3D models that unify polygon and NURBS modeling.

In an aspect, a node vector defines a sphere's center as Equation (3) below with east, west, south, north, pole, and antipolar components indicating direction or force. Flag nodes are single-digit vectors representing extreme values. Each Node vector has four opposing Bearing vectors, with each pair from different Nodes summing to one.

$$\vec{{N}_{ι}} = ( {r}_{i} , {θ}_{i} , {ϕ}_{i} ) \qquad ( 3 )$$

In an aspect, Equation (4) below defines the bearing vector ,B,\vec{ }1 as a unit vector within a spherical coordinate system. In this framework, θi represents the azimuthal angle, which determines the vector's orientation in the horizontal plane, while φi is the polar angle, specifying the vector's elevation from the vertical axis. These two angles precisely locate the bearing vector on the surface of a sphere, with the node vector serving as the origin.

$$\vec{{B}_{ι}} = ( \begin{matrix}sin {ϕ}_{i} cos {θ}_{i} \\ sin {ϕ}_{i} sin {θ}_{i} \\ cos {ϕ}_{i}\end{matrix} ) \qquad ( 4 )$$

In an aspect, the components of B,\vec{ }ᵢ are defined as:
The x-component is given by (sin φ₂ cos θ₂),
The y-component is (sin φ₂ sin θ₂),
The z-component is (cos φ₂).

This decomposition may allow the bearing vector (Equation (5) below) to accurately represent a direction in three-dimensional space using angular coordinates.

$$\vec{{B}_{ι , d}} = ( {B}_{i , d , x} , {B}_{i , d , y} , {B}_{i , d , z} ) \qquad ( 5 )$$

$$\vec{{F}_{ι}} = {F}_{{x}_{i}} \hat{x} + {F}_{{y}_{i}} \hat{y} + {F}_{{z}_{i}} \hat{z} \qquad ( 6 )$$

The vector depth Di quantifies the influence of a specific segment on the i-th bearing vector. This is particularly relevant when a node vector comprises D bearing vectors within a given line segment interval. Essentially, Di determines the extent to which the bearing vector ,B,\vec{ }1 impacts the system, ensuring that each bearing vector's contribution is appropriately scaled based on its depth within the interval.

In an aspect, Equation (6) may describe the force interaction of the bearing vector within a Cartesian coordinate system. The force vector F,\vec{ }i is expressed as a combination of its components along the x, y, and z axes. This Cartesian representation allows for an analysis of the bearing vector's interactions within a three-dimensional space, facilitating the calculation and application of forces acting upon the system.

In an aspect, the structured approach of combining the bearing vector with its corresponding vector depth and force interaction may enable precise modeling of directional influences in a three-dimensional framework. By leveraging angular coordinates for directionality and depth scaling for influence, the disclosed NBV system may accurately analyze and apply directional and force data. This enhances the robustness and reliability of various applications within the model, ensuring that each bearing vector contributes appropriately based on its position and influence within the system.

In the Node Bearing Vector (NBV) system, accurately orienting bearing vectors in three-dimensional space is essential for maintaining the precision and integrity of the generated mesh. Equations (7), (8), and (9) define the rotation matrices that facilitate this orientation based on spherical coordinates. Below is a detailed explanation of each equation and their combined effect.

$${R}_{i} = {R}_{z} ( {θ}_{i} ) {R}_{y} ( {ϕ}_{i} ) \qquad ( 7 )$$

Equation (7) defines the overall rotation matrix RiRi for the ii-th bearing vector. This matrix is a product of two fundamental rotation matrices: one that rotates around the z-axis by an angle θiθi, and another that rotates around the y-axis by an angle φiφi. The sequence of these rotations is crucial for accurately orienting the bearing vector in three-dimensional space.

$${R}_{z} ( {θ}_{i} ) = ( \begin{matrix}cos {θ}_{i} & - sin {θ}_{i} & 0 \\ sin {θ}_{i} & cos {θ}_{i} & 0 \\ 0 & 0 & 1\end{matrix} ) \qquad ( 8 )$$

Equation (8) defines the rotation matrix Rz(θi)Rz(θi) for rotating a vector around the z-axis by an angle fifi. This rotation affects the x and y components of the vector while leaving the z-component unchanged.

$${R}_{y} ( {ϕ}_{i} ) = ( \begin{matrix}cos {ϕ}_{i} & 0 & sin {ϕ}_{i} \\ 0 & 1 & 0 \\ - sin {ϕ}_{i} & 0 & cos {ϕ}_{i}\end{matrix} ) \qquad ( 9 )$$

Equation (9) defines the rotation matrix Ry(φi)Ry(φi) for rotating a vector around the y-axis by an angle φiφi. This rotation affects the x and z components of the vector while keeping the y-component constant.

Rz(θi) rotates the vector around the z-axis, aligning it with the azimuthal angle θi in the horizontal plane. Ry(φi) subsequently rotates the vector around the y-axis, adjusting its elevation to the polar angle φi.

This combined rotation ensures that the bearing vector is correctly oriented according to its spherical coordinates (θi, φi)(θi,φi), facilitating precise placement within the 3D model.

Equation (8) defines the rotation matrix Rz(θi)Rz(θi) for rotating a vector around the z-axis by an angle fifi. This rotation affects the x and y components of the vector while leaving the z-component unchanged.

$$\vec{{V}_{total , s}} = {\sum }_{i = 1}^{{D}_{s}} {d}_{s , i} \cdot ( \vec{{B}_{ι}} ⊗ \vec{{F}_{ι}} ) \qquad ( 10 )$$

Equation (10) represents the summation of the influence of all bearing vectors associated with segment ss. Here:
Ds denotes the vector depth for segment s;
ds,i is the scaling factor corresponding to the ii-th bearing vector in segment ss.
,B,\vec{ }i is the i-th bearing vector;
F,\vec{ }i is the force vector associated with the i-th bearing vector;

The operator ⊗ denotes the element-wise (Hadamard) product.

This cumulative bearing vector, Vtotal,s encapsulates the combined directional and force influences of all bearing vectors within the segment, thereby determining the overall effect on the segment's geometry.

$$\vec{{P}_{final , s}} = \vec{{N}_{Cartesian}} + \vec{{V}_{total , s}} \qquad ( 11 )$$

Equation (11) defines the final Cartesian position Pfinal,s of the node by adding the cumulative bearing vector Vtotal,s to the original node position NCartesian. This addition effectively translates the node position based on the aggregated influence of all bearing vectors, resulting in the precise placement of the node within the 3D space.

$${L}_{d , in} = {L}_{min} + ( {L}_{max} - {L}_{min} ) \cdot \vert \vec{{B}_{d , in}} \vert \qquad ( 12 )$$

$${L}_{d , out} = {L}_{min} + ( {L}_{max} - {L}_{min} ) \cdot \vert \vec{{B}_{d , out}} \vert \qquad ( 13 )$$

Equations (12) and (13) determine the lengths Ld,in and Ld,out of the bearing vector bars for incoming and outgoing vectors, respectively, at depth d. The lengths are scaled based on the magnitude of the bearing vectors B, in and B,d, out, ensuring that the visual representation accurately reflects the influence of each vector. The parameters Lmin and Lmax define the minimum and maximum lengths of the bearing vector bars, providing a normalized scale for visualization.

$$\vec{B} ( t ) = {\sum }_{i = 0}^{n} ( \begin{matrix}n \\ i\end{matrix} ) {( 1 - t )}^{n - 1} {t}^{i} \vec{{P}_{ι}} , 0 \leq t \leq 1 \qquad ( 14 )$$

Equation (14) defines the Bezier curve B,\vec{ }(t) of degree n that connects two nodes. The control points P,\vec{ }i influence the shape of the curve, allowing for smooth transitions and curvature based on the vector depths and positions of the nodes. The parameter t varies between 0 and 1, representing the progression along the curve from the start node to the end node.

$$\vec{{P}_{0}} = \vec{{N}_{1}} \qquad ( 15 )$$

$$\vec{{P}_{ι}} = \vec{{N}_{1}} + \vec{{C}_{1 , ι}} , 1 \leq i \leq {D}_{1} \qquad ( 16 )$$

$$\vec{{P}_{{D}_{1} + 1}} = α ( \vec{{N}_{1}} + \vec{{C}_{1 , {D}_{1}}} ) + ( 1 - α ) ( \vec{{N}_{2}} - \vec{{C}_{2 , {D}_{2}}} ) \qquad ( 17 )$$

$$\vec{{P}_{{D}_{1} + 1 + j}} = \vec{{N}_{2}} - \vec{{C}_{2 , {D}_{2} - j + 1}} , 1 \leq j \leq {D}_{2} \qquad ( 18 )$$

$$\vec{{P}_{n}} = \vec{{N}_{2}} \qquad ( 19 )$$

Equations (15) to (19) outline the construction of control points for the Bezier curve:

Equation (15): The first control point, P₀ is set to the position of the first node N₀(\vec{ }.

Equation (16): Intermediate control points P₁ for 1≤i≥D₁ are offset from N by the corresponding curvature vectors C_{1,1}

Equation (17): The central control point P_{D1}+1 is a weighted average, controlled by the parameter α, between the last curvature vector of the first node and the first curvature vector of the second node N₁.

Equation (18): Subsequent control points P₁ (B₁ for 1≤j≤D) are offset from N₁ by the corresponding curvature vectors C1_{,1}B₁.

Equation (19): The final control point Pn is set to the position of the second node N₂.

The parameter α (where 0≤α≥10≤α≤1) allows for user-defined control over the influence of the curvature vectors, enabling fine-tuning of the curve's shape to achieve the desired mesh connectivity and smoothness.

$$κ ( t ) = \frac{\vert \vec{{B}^{″}} ( t ) \times \vec{{B}^{′}} ( t ) \vert}{{\vert \vec{{B}^{′}} ( t ) \vert}^{3}} \qquad ( 20 )$$

Equation (20) defines the curvature κ(t) at any point t along the Bezier curve B\vec{ }(t)B(t). Here:
B′\vec{ }(t)B′(t) and B″\vec{ }(t)B″(t) are the first and second derivatives of the Bezier curve with respect to tt, representing the tangent and acceleration vectors, respectively.
The cross product B″\vec{ }(t)×B′\vec{ }(t)B″(t)×B′(t) measures the rate of change of the tangent vector, providing a measure of how sharply the curve is turning.
The denominator |B′\vec{ }(t)|3|B′(t)|3 normalizes the curvature, ensuring that κ(t)κ(t) is scale-invariant.

This curvature analysis is crucial for ensuring that the generated mesh maintains smooth transitions and adheres to the desired geometric properties, thereby enhancing the visual and structural quality of the 3D model.

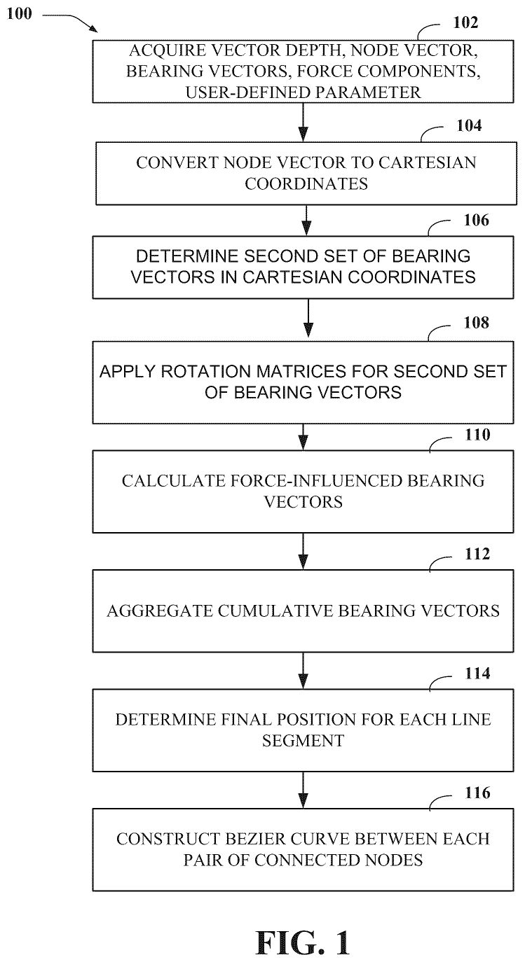

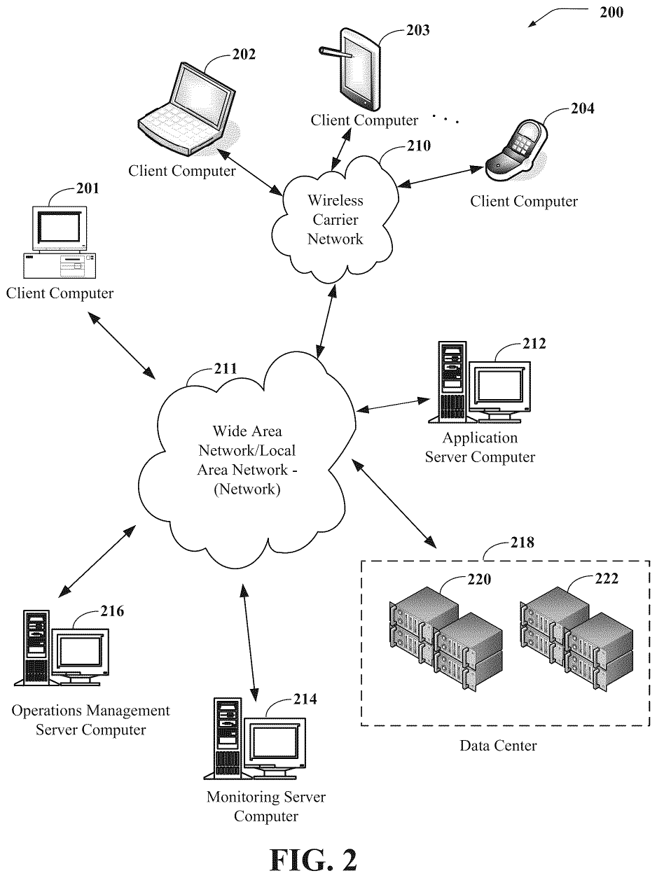

FIG. 1 illustrates a flowchart 100 for acts taken in an exemplary method for 3D modeling. FIG. 1 is explained in conjunction with FIG. 2 to FIG. 4 herein. The control starts at act 102.

At act 102, the system acquire, for each node in a 3D dataset, a node vector in spherical coordinates; a vector depth for each node; a first set of bearing vectors at each depth; force components at each bearing vector; and a user-defined parameter for each pair of connected nodes nodei and nodej. In an aspect, the system may acquire the vector depth for each node by acquiring a number of bearing vectors associated with nodei. In an aspect, the system may acquire the force components at each bearing vector by acquiring force magnitudes along x, y, and z cartesian axes, respectively, at each bearing vector.

At act 104, the system may convert the node vector to cartesian coordinates to create a cartesian node vector. In an aspect, the system may use Equation (4) and the respective cartesian components of Equation (4) above to perform the conversion.

At act 106, the system may determine a second set of bearing vectors in cartesian coordinates. In an aspect, the system may use Equation (4) and the respective cartesian components of Equation (4) above to perform the calculations.

At act 108, the system may apply rotation matrices for each of the second set of bearing vectors. In an aspect, the system may use Equations (7-9) to perform the calculations.

At act 110, the system may calculate force-influenced bearing vectors. In an aspect, the system may use Equations (5-6) above to perform the calculations.

At act 112, the system may aggregate cumulative bearing vectors for each line segment between each pair of connected nodes nodei and nodej. In an aspect, the system may, for each line segment s between nodes, sum the contributions from all bearing vectors associated with that segment.

At act 114, the system may determine a final position for each line segment between each pair of connected nodes nodei and nodej by adding the cumulative bearing vectors to the cartesian node vector. In an aspect, the system may compute the final position for each segment by adding the cumulative bearing vector to the cartesian node vector.

At act 116, the system may construct a Bezier curve between each pair of connected nodes nodei and nodej. In an aspect, the system may construct the Bezier curve by using the vector depth, the user-defined parameter, and control points influenced by the bearing vectors and the user-defined parameter to connect each pair of connected nodes nodei and nodej. In an aspect, the system may adjust the control points based on the cumulative bearing vectors of each line segment.

In a further aspect of the disclosure, the system may determine a curvature of the Bezier curve between each pair of connected nodes nodei and nodej. The curvature of the Bezier curve may be used to analyze its geometric properties. In an aspect, the system may use Equation (20) above to determine the curvature of the Bezier curve.

In an aspect of the disclosure, the system may determine a length of the bearing vector at the vector depth based on a magnitude of each bearing vector for graphic visualization of the bearing vectors.

Some potential advantages and improvements resulting from the disclosed NBV modeling system and method include, but are not limited to:

Unified Modeling Approach: By integrating polygonal modeling with NURBS through the use of node vectors, bearing vectors, variable edge lengths, and vector depth, the NBV system offers a cohesive framework that combines the strengths of both methods.

Node and Bearing Vectors: Introducing node vectors and bearing vectors allows for a new way of representing 3D geometry. This method captures the directional and positional information of points in space more efficiently than traditional vertex representations.

Variable Edge Lengths and Vector Depth: These concepts enable dynamic control over the model's geometry, allowing for detailed adjustments at various levels of the mesh without significantly increasing complexity or memory usage.

Normalized Fixed-Point Representation: Utilizing a 64-bit normalized fixed-point integer format to represent numbers between −1 and 1 enhances computational precision and reduces rounding errors compared to standard floating-point representations. This approach combines the speed of integer operations with the accuracy of floating-point calculations.

Enhanced Memory Efficiency: The NBV system reduces the need for large polygon counts to achieve smooth surfaces, resulting in smaller file sizes and lower memory consumption.

Real-Time Interaction with Near-NURBS Accuracy: By providing a polygon-editing interface that supports real-time manipulation while maintaining high-quality surface representations, the system improves the user experience and workflow efficiency.

Optimized for GPU Parallelism: The design of the NBV system leverages GPU parallel processing capabilities to enhance performance, particularly in reducing data loss during coordinate transformations and improving rendering times.

Flexibility Across Industries: The system's ability to produce high-quality results with improved efficiency makes it applicable to various fields, including architecture, video game development, and product design.

FIG. 2 shows components of one aspect of a computing environment 200 for the disclosed NBV system and method. Not all the components may be required to practice various aspects, and variations in the arrangement and type of the components may be made. As shown, the computing environment 200 includes local area networks (LANs)/wide area networks (WANs) (i.e., a network 211), a wireless network 210, client computers 201-204, an application server computer 212, a monitoring server computer 214, and an operations management server computer 216, which may be or may implement the disclosed NBV system.

Generally, the client computers 201-204 may include virtually any portable computing device capable of receiving and sending a message over a network, such as the network 211, the wireless network 210, or the like. The client computers 201-204 may also be described generally as client computers that are configured to be portable. Thus, the client computers 201-204 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 201-204 may include Internet-of-Things (IOT) devices as well. Accordingly, the client computers 201-204 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 201 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one aspect, at least some of the client computers 201-204 may operate over wired and/or wireless network. Today, many of these devices include a capability to access and/or otherwise communicate over a network such as the network 211 and/or the wireless network 210. Moreover, the client computers 201-204 may access various computing applications, including a browser, or other web-based application.

In one aspect, one or more of the client computers 201-204 may be configured to operate within a business or other entity to perform a variety of services for the business or other entity. For example, a client of the client computers 201-204 may be configured to operate as a web server, an accounting server, a production server, an inventory server, or the like. However, the client computers 201-204 are not constrained to these services and may also be employed, for example, as an end-user computing node, in other aspects. Further, it should be recognized that more or less client computers may be included within a system such as described herein, and aspects are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one aspect, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, or the like, to display and send a message. In one aspect, a user of the client computer may employ the browser application to perform various actions over a network.

The client computers 201-204 also may include at least one other client application that is configured to receive and/or send data, operations information, between another computing device. The client application may include a capability to provide requests and/or receive data relating to managing, operating, or configuring the operations management server computer 216.

The wireless network 210 can be configured to couple the client computers 201-204 with network 211. The wireless network 210 may include any of a variety of wireless sub-networks that may further overlay stand-alone ad-hoc networks, or the like, to provide an infrastructure-oriented connection for the client computers 201-204. Such sub-networks may include mesh networks, Wireless LAN (WLAN) networks, cellular networks, or the like.

The wireless network 210 may further include an autonomous system of terminals, gateways, routers, or the like connected by wireless radio links, or the like. These connectors may be configured to move freely and randomly and organize themselves arbitrarily, such that the topology of the wireless network 210 may change rapidly.

The wireless network 210 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 201-204 with various degrees of mobility. For example, the wireless network 210 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, the wireless network 210 may include virtually any wireless communication mechanism by which information may travel between the client computers 201-204 and another computing device, network, or the like.

The network 211 can be configured to couple network devices with other computing devices, including, the operations management server computer 216, the monitoring server computer 214, the application server computer 212, the client computer 101, and through the wireless network 210 to the client computers 201-204. The network 211 can be enabled to employ any form of computer readable media for communicating information from one electronic device to another. Also, the network 211 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 211 and the wireless network 210. Furthermore, remote computers and other related electronic devices could be remotely connected to either LANs or WANs via a modem and temporary telephone link. In essence, the network 211 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

The operations management server computer 216 may include virtually any network computer usable to provide computer operations management services, such as a network computer. In one aspect, the operations management server computer 216 employs various techniques for managing the operations of computer operations, networking performance, customer service, customer support, resource schedules and notification policies, event management, or the like. Also, the operations management server computer 216 may be arranged to interface/integrate with one or more external systems such as telephony carriers, email systems, web services, or the like, to perform computer operations management. Further, the operations management server computer 216 may obtain various events and/or performance metrics collected by other systems, such as, the monitoring server computer 214.

In at least one of the various aspects, the monitoring server computer 214 represents various computers that may be arranged to monitor the performance of computer operations for an entity (e.g., company or enterprise). For example, the monitoring server computer 214 may be arranged to monitor whether applications/systems are operational, network performance, trouble tickets and/or their resolution, or the like. In some aspects, one or more of the functions of the monitoring server computer 214 may be performed by the operations management server computer 216.

Devices that may operate as the operations management server computer 216 include various network computers, including, but not limited to personal computers, desktop computers, multiprocessor systems, microprocessor-based or programmable consumer electronics, network PCs, server devices, network appliances, or the like. It should be noted that while the operations management server computer 216 is illustrated as a single network computer, the invention is not so limited. Thus, the operations management server computer 216 may represent a plurality of network computers. For example, in one aspect, the operations management server computer 216 may be distributed over a plurality of network computers and/or implemented using cloud architecture.

Moreover, the operations management server computer 216 is not limited to a particular configuration. Thus, the operations management server computer 216 may operate using a master/slave approach over a plurality of network computers, within a cluster, a peer-to-peer architecture, and/or any of a variety of other architectures.

In some aspects, one or more data centers, such as a data center 218, may be communicatively coupled to the wireless network 210 and/or the network 211. In at least one of the various aspects, the data center 218 may be a portion of a private data center, public data center, public cloud environment, or private cloud environment. In some aspects, the data center 218 may be a server room/data center that is physically under the control of an organization. The data center 218 may include one or more enclosures of network computers, such as, an enclosure 220 and an enclosure 222.

The enclosure 220 and the enclosure 222 may be enclosures (e.g., racks, cabinets, or the like) of network computers and/or blade servers in the data center 218. In some aspects, the enclosure 220 and the enclosure 222 may be arranged to include one or more network computers arranged to operate as operations management server computers, monitoring server computers (e.g., the operations management server computer 216, the monitoring server computer 214, or the like), storage computers, or the like, or combination thereof. Further, one or more cloud instances may be operative on one or more network computers included in the enclosure 120 and the enclosure 222.

The data center 218 may also include one or more public or private cloud networks. Accordingly, the data center 218 may comprise multiple physical network computers, interconnected by one or more networks, such as, networks similar to and/or the including network 211 and/or wireless network 210. The data center 218 may enable and/or provide one or more cloud instances (not shown). The number and composition of cloud instances may be vary depending on the demands of individual users, cloud network arrangement, operational loads, performance considerations, application needs, operational policy, or the like. In at least one of the various aspects, the data center 218 may be arranged as a hybrid network that includes a combination of hardware resources, private cloud resources, public cloud resources, or the like.

As such, the operations management server computer 216 is not to be construed as being limited to a single environment, and other configurations, and architectures are also contemplated. The operations management server computer 216 may employ processes such as described below in conjunction with at least some of the figures discussed below to perform at least some of its actions.

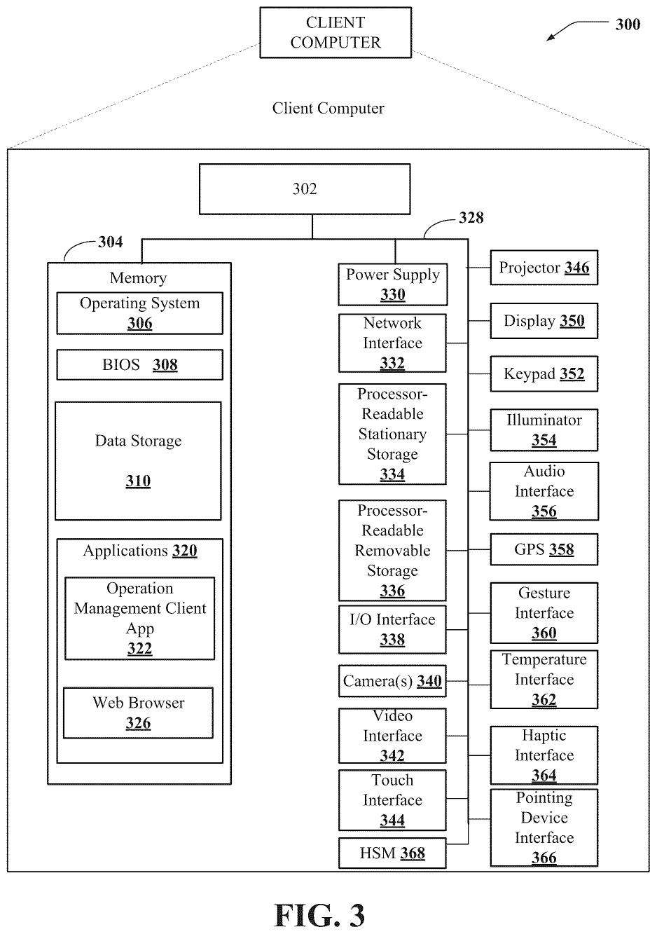

FIG. 3 shows one aspect of a client computer 300. The client computer 300 may include more or less components than those shown in FIG. 2. The client computer 300 may represent, for example, at least one aspect of mobile computers or client computers shown in FIG. 1.

The client computer 300 may include a processor 302 in communication with a memory 304 via a bus 328. The client computer 300 may also include a power supply 330, a network interface 342, an audio interface 356, a display 350, a keypad 352, an illuminator 354, a video interface 342, an input/output interface (i.e., an I/O interface 338), a haptic interface 364, a global positioning systems (GPS) receiver 358, an open air gesture interface 360, a temperature interface 362, a camera 340, a projector 346, a pointing device interface 366, a processor-readable stationary storage device 344, and a non-transitory processor-readable removable storage device 336. The client computer 300 may optionally communicate with a base station (not shown), or directly with another computer. And in one aspect, although not shown, a gyroscope may be employed within the client computer 300 to measuring or maintaining an orientation of the client computer 300.

The power supply 330 may provide power to the client computer 300. A rechargeable or non-rechargeable battery may be used to provide power. The power may also be provided by an external power source, such as an AC adapter or a powered docking cradle that supplements or recharges the battery.

The network interface 342 includes circuitry for coupling the client computer 300 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 342 is sometimes known as a transceiver, transceiving device, or network interface card (NIC).

The audio interface 356 may be arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the client computer 300, e.g., using voice recognition, detecting touch based on sound, and the like.

The display 350 may be a liquid crystal display (LCD), gas plasma, electronic ink, light emitting diode (LED), Organic LED (OLED) or any other type of light reflective or light transmissive display that can be used with a computer. The display 350 may also include a touch interface 344 arranged to receive input from an object such as a stylus or a digit from a human hand, and may use resistive, capacitive, surface acoustic wave (SAW), infrared, radar, or other technologies to sense touch or gestures.

[1] The projector 346 may be a remote handheld projector or an integrated projector that is capable of projecting an image on a remote wall or any other reflective object such as a remote screen.

The video interface 342 may be arranged to capture video images, such as a still photo, a video segment, an infrared video, or the like. For example, the video interface 342 may be coupled to a digital video camera, a web-camera, or the like. The video interface 342 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 352 may comprise any input device arranged to receive input from a user. For example, the keypad 352 may include a push button numeric dial, or a keyboard. The keypad 352 may also include command buttons that are associated with selecting and sending images.

The illuminator 354 may provide a status indication or provide light. The illuminator 354 may remain active for specific periods of time or in response to event messages. For example, when the illuminator 354 is active, it may backlight the buttons on the keypad 352 and stay on while the client computer is powered. Also, the illuminator 354 may backlight these buttons in various patterns when particular actions are performed, such as dialing another client computer. The illuminator 354 may also cause light sources positioned within a transparent or translucent case of the client computer to illuminate in response to actions.

Further, the client computer 300 may also comprise a hardware security module (i.e., an HSM 368) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 368 may be a stand-alone computer, in other cases, the HSM 268 may be arranged as a hardware card that may be added to a client computer.

The I/O 338 can be used for communicating with external peripheral devices or other computers such as other client computers and network computers. The peripheral devices may include an audio headset, display screen glasses, remote speaker system, remote speaker and microphone system, and the like. The I/O interface 338 can utilize one or more technologies, such as Universal Serial Bus (USB), Infrared, WiFi, WiMax, Bluetooth™, and the like.

The I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 300.

The haptic interface 364 may be arranged to provide tactile feedback to a user of the client computer. For example, the haptic interface 364 may be employed to vibrate the client computer 300 in a particular way when another user of a computer is calling. The temperature interface 362 may be used to provide a temperature measurement input or a temperature changing output to a user of the client computer 300. The open air gesture interface 360 may sense physical gestures of a user of the client computer 300, for example, by using single or stereo video cameras, radar, a gyroscopic sensor inside a computer held or worn by the user, or the like. The camera 340 may be used to track physical eye movements of a user of the client computer 300.

The GPS transceiver 358 can determine the physical coordinates of the client computer 300 on the surface of the earth, which typically outputs a location as latitude and longitude values. The GPS transceiver 358 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 300 on the surface of the earth. It is understood that under different conditions, the GPS transceiver 358 can determine a physical location for the client computer 300. In at least one aspect, however, the client computer 300 may, through other components, provide other information that may be employed to determine a physical location of the client computer, including for example, a Media Access Control (MAC) address, IP address, and the like.

Human interface components can be peripheral devices that are physically separate from the client computer 300, allowing for remote input or output to the client computer 300. For example, information routed as described here through human interface components such as the display 350 or the keypad 352 can instead be routed through the network interface 342 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 326 that is configured to receive and to send web pages, web-based messages, graphics, text, multimedia, and the like. The client computer's browser application may employ virtually any programming language, including a wireless application protocol messages (WAP), and the like. In at least one aspect, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

The memory 304 may include RAM, ROM, or other types of memory. The memory 304 illustrates an example of computer-readable storage media (devices) for storage of information such as computer-readable instructions, data structures, program modules or other data. The memory 304 may store a BIOS 308 for controlling low-level operation of the client computer 300. The memory may also store an operating system 306 for controlling the operation of the client computer 300. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 304 may further include one or more data storage 210, which can be utilized by the client computer 300 to store, among other things, the applications 320 or other data. For example, the data storage 310 may also be employed to store information that describes various capabilities of the client computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like.

The data storage 310 may further include program code, data, algorithms, and the like, for use by a processor, such as the processor 302 to execute and perform actions. In one aspect, at least some of the data storage 310 might also be stored on another component of the client computer 300, including, but not limited to, the non-transitory processor-readable removable storage device 336, the processor-readable stationary storage device 344, or external to the client computer.

The applications 320 may include computer executable instructions which, when executed by the client computer 300, transmit, receive, or otherwise process instructions and data. The applications 320 may include, for example, an operations management client application 322. In at least one of the various aspects, the operations management client application 322 may be used to exchange communications to and from the operations management server computer 316 of FIG. 2, the monitoring server computer 214 of FIG. 2, the application server computer 212 of FIG. 2, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more aspects (not shown in the figures), the client computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the client computer 300 may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

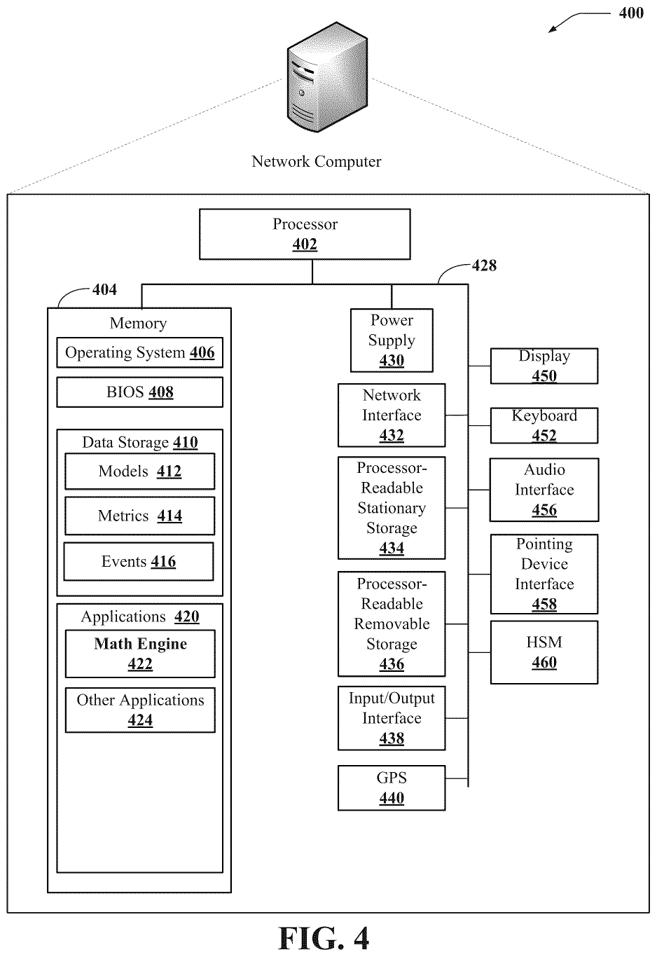

FIG. 4 shows one aspect of network computer 400 that may at least partially implement one of the various aspects. The network computer 400 may include more or fewer components than those shown in FIG. 4. The network computer 400 may represent, for example, one aspect of at least one NBV system according to the disclosure, such as the operations management server computer 216 of FIG. 2, the monitoring server computer 214 of FIG. 2, or an application server computer 212 of FIG. 2. Further, in some aspects, the network computer 400 may represent one or more network computers included in a data center, such as, the data center 218, the enclosure 220, the enclosure 222, or the like.

As shown in the FIG. 4, the network computer 400 includes a processor 402 in communication with a memory 404 via a bus 428. The network computer 400 also includes a power supply 430, a network interface 442, an audio interface 456, a display 450, a keyboard 452, an input/output interface (i.e., an I/O interface 438), a processor-readable stationary storage device 444, and a processor-readable removable storage device 436. The power supply 430 provides power to the network computer 300.

The network interface 442 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 442 is sometimes known as a transceiver, transceiving device, or network interface card (NIC). The network computer 400 may optionally communicate with a base station (not shown), or directly with another computer.

The audio interface 456 is arranged to produce and receive audio signals such as the sound of a human voice. For example, the audio interface 456 may be coupled to a speaker and microphone (not shown) to enable telecommunication with others or generate an audio acknowledgement for some action. A microphone in the audio interface 456 can also be used for input to or control of the network computer 300, for example, using voice recognition.

The display 450 may be a liquid crystal display (LCD), gas plasma, electronic ink, light emitting diode (LED), Organic LED (OLED) or any other type of light reflective or light transmissive display that can be used with a computer. The display 450 may be a handheld projector or pico projector capable of projecting an image on a wall or other object.

The network computer 400 may also comprise the I/O interface 438 for communicating with external devices or computers not shown in FIG. 4. The I/O interface 438 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 438 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 400. Human interface components can be physically separate from network computer 400, allowing for remote input or output to the network computer 400. For example, information routed as described here through human interface components such as the display 450 or the keyboard 452 can instead be routed through the network interface 442 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 458 to receive user input.

A GPS transceiver 440 can determine the physical coordinates of network computer 300 on the surface of the Earth, which typically outputs a location as latitude and longitude values. The GPS transceiver 440 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 400 on the surface of the Earth. It is understood that under different conditions, the GPS transceiver 440 can determine a physical location for the network computer 300. In at least one aspect, however, the network computer 300 may, through other components, provide other information that may be employed to determine a physical location of the client computer, including for example, a Media Access Control (MAC) address, IP address, and the like.

The memory 404 may include Random Access Memory (RAM), Read-Only Memory (ROM), or other types of memory. The memory 404 illustrates an example of computer-readable storage media (devices) for storage of information such as computer-readable instructions, data structures, program modules or other data. The memory 404 stores a basic input/output system (i.e., a BIOS 408) for controlling low-level operation of the network computer 400. The memory also stores an operating system 406 for controlling the operation of the network computer 400. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 404 may further include a data storage 410, which can be utilized by the network computer 400 to store, among other things, applications 420 or other data. For example, the data storage 410 may also be employed to store information that describes various capabilities of the network computer 400. The information may then be provided to another device or computer based on any of a variety of methods, including being sent as part of a header during a communication, sent upon request, or the like. The data storage 410 may also be employed to store social networking information including address books, buddy lists, aliases, user profile information, or the like. The data storage 410 may further include program code, instructions, data, algorithms, and the like, for use by a processor, such as the processor 402 to execute and perform actions such as those actions described below. In one aspect, at least some of the data storage 410 might also be stored on another component of the network computer 400, including, but not limited to, the non-transitory media inside processor-readable removable storage device 436, the processor-readable stationary storage device 444, or any other computer-readable storage device within the network computer 400 or external to network computer 400. The data storage 410 may include, for example, models 412, operations metrics 414, events 416, or the like.

The applications 420 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 420 may include a math engine 422 for performing the calculations described in the present disclosure, such as matrix multiplication routines and other applications 424 such as graphics display and rendering applications. In at least one of the various aspects, one or more of the applications may be implemented as modules or components of another application. Further, in at least one of the various aspects, applications may be implemented as operating system extensions, modules, plugins, or the like.

Furthermore, in at least one of the various aspects, the math engine 422 and/or other applications 424, or the like, may be operative in a cloud-based computing environment. In at least one of the various aspects, these applications, and others, that comprise the management platform may be executing within virtual machines or virtual servers that may be managed in a cloud-based based computing environment. In at least one of the various aspects, in this context the applications may flow from one physical network computer within the cloud-based environment to another depending on performance and scaling considerations automatically managed by the cloud computing environment. Likewise, in at least one of the various aspects, virtual machines or virtual servers dedicated to the math engine 422 for performing the calculations described in the present disclosure, such as matrix multiplication routines and other applications 424 such as graphics display and rendering applications, may be provisioned and de-commissioned automatically.

Also, in at least one of the various aspects, the math engine 422 for performing the calculations described in the present disclosure, such as matrix multiplication routines and other applications 424 such as graphics display and rendering applications, may be located in virtual servers running in a cloud-based computing environment rather than being tied to one or more specific physical network computers.

Further, the network computer 400 may also comprise hardware security module (i.e., an HSM 460) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 460 may be a stand-alone network computer, in other cases, the HSM 460 may be arranged as a hardware card that may be installed in a network computer.

Additionally, in one or more aspects (not shown in the figures), the network computer 400 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the network computer may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

Blocks of the flowchart 100 support combinations of means for performing the specified functions and combinations of operations for performing the specified functions. It will also be understood that one or more blocks of the flowchart 100, and combinations of blocks in the flowchart 100, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, the processor 302 and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present invention and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory

Many modifications and other aspects of the inventions set forth herein will come to mind to one skilled in the art to which these inventions pertain having the benefit of the teachings presented in the foregoing descriptions and the associated drawings. Therefore, it is to be understood that the inventions are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for three-dimensional (3D) modeling, the method comprising:
acquiring, for each node in a 3D dataset, a node vector in spherical coordinates; a vector depth for each node; a first set of bearing vectors at each depth; force components at each bearing vector; and a user-defined parameter for each pair of connected nodes nodei and nodej;
converting the node vector to cartesian coordinates to create a cartesian node vector;
determining a second set of bearing vectors in cartesian coordinates;
applying rotation matrices for each of the second set of bearing vectors;
calculating force-influenced bearing vectors;
aggregating cumulative bearing vectors for each line segment between each pair of connected nodes nodei and nodej;
determining a final position for each line segment between each pair of connected nodes nodei and nodej by adding the cumulative bearing vectors to the cartesian node vector; and
constructing a Bezier curve between each pair of connected nodes nodei and nodej.

2. The method of claim 1, further comprising determining a curvature of the Bezier curve between each pair of connected nodes nodei and nodej.

3. The method of claim 1, where constructing the Bezier curve comprises using the vector depth, the user-defined parameter, and control points influenced by the bearing vectors and the user-defined parameter to connect each pair of connected nodes nodei and nodej.

4. The method of claim 3, further comprising adjusting the control points based on the cumulative bearing vectors of each line segment.

5. The method of claim 1, where acquiring the vector depth for each node comprises acquiring a number of bearing vectors associated with nodei.

6. The method of claim 1, where acquiring the force components at each bearing vector comprises acquiring force magnitudes along x, y, and z cartesian axes, respectively, at each bearing vector.

7. The method of claim 1, further comprising determining a length of the bearing vector at the vector depth based on a magnitude of each bearing vector.

8. A system for 3D modeling, the system comprising:
at least one memory configured to store computer executable instructions; and at least one processor configured to execute the computer executable instructions to:
acquire, for each node in a 3D dataset, a node vector in spherical coordinates; a vector depth for each node; a first set of bearing vectors at each depth; force components at each bearing vector; and a user-defined parameter for each pair of connected nodes nodei and nodej;
convert the node vector to cartesian coordinates to create a cartesian node vector;
determine a second set of bearing vectors in cartesian coordinates;
applying rotation matrices for each of the second set of bearing vectors;
calculate force-influenced bearing vectors;
aggregate cumulative bearing vectors for each line segment between each pair of connected nodes nodei and nodej;
determine a final position for each line segment between each pair of connected nodes nodei and nodej by adding the cumulative bearing vectors to the cartesian node vector; and
construct a Bezier curve between each pair of connected nodes nodei and nodej.

9. The system of claim 8, further comprising computer executable instructions to determine a curvature of the Bezier curve between each pair of connected nodes nodei and nodej.

10. The system of claim 8, where the computer executable instructions to construct the Bezier curve comprise computer executable instructions to use the vector depth, the user-defined parameter, and control points influenced by the bearing vectors and the user-defined parameter to connect each pair of connected nodes nodei and nodej.

11. The system of claim 10, further comprising computer executable instructions to adjust the control points based on the cumulative bearing vectors of each line segment.

12. The system of claim 8, where the computer executable instructions to acquiring the vector depth for each node comprises acquiring a number of bearing vectors associated with nodei.

13. The system of claim 8, where acquiring the force components at each bearing vector comprises acquiring force magnitudes along x, y, and z cartesian axes, respectively, at each bearing vector.

14. The system of claim 8, further comprising computer executable instructions to determine a length of the bearing vector at the vector depth based on a magnitude of each bearing vector.

15. A computer program product comprising a non-transitory computer readable medium having stored thereon computer executable instructions, which when executed by one or more processors, cause the one or more processors to perform a 3D modeling, the operations comprising:
acquiring, for each node in a 3D dataset, a node vector in spherical coordinates; a vector depth for each node; a first set of bearing vectors at each depth; force components at each bearing vector; and a user-defined parameter for each pair of connected nodes nodei and nodej;
converting the node vector to cartesian coordinates to create a cartesian node vector;
determining a second set of bearing vectors in cartesian coordinates;
applying rotation matrices for each of the second set of bearing vectors;
calculating force-influenced bearing vectors;
aggregating cumulative bearing vectors for each line segment between each pair of connected nodes nodei and nodej;
determining a final position for each line segment between each pair of connected nodes nodei and nodej by adding the cumulative bearing vectors to the cartesian node vector; and
constructing a Bezier curve between each pair of connected nodes nodei and nodej.

16. The computer program product of claim 15, further operations for comprising determining a curvature of the Bezier curve between each pair of connected nodes nodei and nodej.

17. The computer program product of claim 15, where the operations for constructing the Bezier curve comprises operations for using the vector depth, the user-defined parameter, and control points influenced by the bearing vectors and the user-defined parameter to connect each pair of connected nodes nodei and nodej.

18. The computer program product of claim 17, further comprising operations for adjusting the control points based on the cumulative bearing vectors of each line segment.

19. The computer program product of claim 15, where the operations for acquiring the vector depth for each node comprises operations for acquiring a number of bearing vectors associated with nodei.

20. The computer program product of claim 15, where the operations for acquiring the force components at each bearing vector comprises operations for acquiring force magnitudes along x, y, and z cartesian axes, respectively, at each bearing vector.
